(19) United States
(12) Patent Application Publication
(10) Pub. No.: US 2026/0188956 A1
(43) Pub. Date: Jul. 2, 2026

(54) LAN CABLE AND CONNECTOR FOR LAN CABLE

(71) Applicant: Canare Electric Co., Ltd., Nisshin-shi, Aichi (JP)

(72) Inventors: Hiroshi ZUSHI, Yokohama-shi, Kanagawa (JP); Junichirou TANABE, Yokohama-shi, Kanagawa (JP); Yoshiki CHIGUSA, Yokohama-shi, Kanagawa (JP); Naoki KINOSHITA, Yokohama-shi, Kanagawa (JP); Hisaya KOBAYASHI, Yokohama-shi, Kanagawa (JP)

(21) Appl. No.: 18/725,002

(22) PCT Filed: Oct. 12, 2023
(86) PCT No.: PCT/JP2023/037035

§ 371 Date: Mar. 18, 2026

(51) Int. Cl. H01R 13/66; H01R 24/20; H01R 24/64

(52) U.S. Cl. CPC H01R 13/6633; H01R 13/6658; H01R 24/20; H01R 24/64; H01R 2201/04

(57) ABSTRACT

A LAN cable to make possible data communication between transmission system devices that perform data communication using a differential signal while exceeding the maximum standardized transmission distance of 100 m. The LAN cable includes a LAN cable body having n (n is an integer equal to or greater than 4) unbalanced cables as n pairs of signal lines housed in a sheath, and a connector plug to be provided to at least one end of the LAN cable body. The connector plug includes n pairs of contact pins, a circuit substrate, and a connector body for surrounding these. The circuit substrate includes: n pairs of signal line-side terminals electrically connected to the respective conductor pairs of the unbalanced cables; n pairs of pin-side terminals electrically connected to the respective pairs of the n pairs of the contact pins; n units of surface-mounted balanced to unbalanced converters; and electric wirings for establishing one-to-one electric connection among the respective pairs of the n pairs of signal line-side terminals, the respective converters of the n units of the surface-mounted balanced to unbalanced converters, and the respective pairs of the n pairs of the pin-side terminals.

### TECHNICAL FIELD

The present invention generally relates to a LAN cable and a LAN cable connector. Specifically, the present invention relates to an electric LAN cable having its transmission distance extended, and a connector to be used for the LAN cable.

### BACKGROUND ART

There are various types of LAN cables which connect transmission system devices for data communication. Among others, a LAN cable of TP type has been widely used, which houses four pairs of twisted pair wires in a cable sheath, and has both ends fitted with 8P8C (eight position, eight conductors) modular connectors (specifically, RJ45), respectively. The LAN cable of this type functions as a transmission line for differential signal data communication between the transmission system devices.

According to Ethernet standard standardized by IEEE (Institute of Electrical and Electronics Engineers) 802.3i, currently employed LAN cables adapted to the transmission speed at 1 Gbps or hither, that is, 1000 BASE-T or higher are classified as categories 6A, 6, and 5e (CAT6A, CAT6, CAT5e) prescribed by ANSI/TIA/EIA-568 (ANSI: American National Standards Institute, TIA: Telecommunication Industries Association, EIA: Electronic Industries Association).

The LAN cables of TP type belonging to electric LAN cables classified as CAT6A, CAT6, and CAT5e are designed to cover the transmission distance of 100 m at the maximum. In other words, the currently employed LAN cables of TP type are not designed to cover the long transmission distance in excess of 100 m, up to 200 m.

A transmission system using optical fiber cables and optical modules is expected to cover the long transmission distance in excess of 100 m. The transmission system that covers the long transmission distance, however, requires significantly higher costs than those when using the electric LAN cable. This makes it difficult to design the transmission system for the use in the broadcasting station or the like. Actually, in most cases, the system for the use in the broadcasting station or the like covers the transmission distance between the transmission system devices in the range in excess of 100 m, up to 200 m.

The use of the electric LAN cable having the transmission distance extended up to 200 m at the maximum may eliminate the need for using the costly optical fiber cables and optical modules. The electric LAN cable having the transmission distance extended as described above may cover more than 80% of the data transmission in the broadcasting station.

Generally, the long transmission distance over 100 m causes the problem that an additional power source is necessary. In the case of signal transmission using the optical fiber cable and the optical module, the power source for power supply to the optical module is necessary. Alternatively, in the case of signal transmission using the generally employed electric LAN cable which covers the distance in excess of 100 m, the active device such as a repeater has to be disposed between the LAN cables, and operated. Requirement of the power source for the active device causes the complication of the design of the transmission system, resulting in the problem of increase in the operation cost.

Meanwhile, there is known a technology which connects transmission system devices for single-ended signal data communication via an unbalanced cable (coaxial cable) instead of using differential signal. For example, according to the standard 10BASE-5 or 10BASE-2, the use of an N type connector and a 50Ω coaxial cable attains coverage of the transmission distance of 500 m at the maximum, or the use of a 50Ω coaxial cable with BNC connector attains coverage of the transmission distance of 185 m at the maximum.

There is known a technology which connects transmission system devices for performing data communication using differential signal in a network environment where balance and unbalanced cables are mixedly used (for example, Patent Literatures 1, 2, 3).

Patent Literatures 1 and 2 disclose a connector incorporated type balanced to unbalanced converter (which can be referred to as “balun”) which connects an information wiring system for balance signal communication, and an unbalance signal communication system using the information wiring system as a transmission line. The balanced to unbalanced converter is incorporated into the connector body of the transmission medium to be used. At one end of a balanced cable with twisted pair wire, a modular connector is provided, and the other end thereof, a BNC connector is provided. The balanced to unbalanced converter constituted by transformer using a toroidal core is incorporated into the BNC connector body.

Patent Literature 3 discloses a converter cable which connects a balanced to unbalanced converter to one end of a coaxial cable or a balanced pair cable. The balanced to unbalanced converter is configured to connect inductors and capacitors to a winding of transformer using a core at the constant with the specific order. As an example of the converter cable, a modular plug is provided at one end of a balanced cable, and the balanced to unbalanced converter is provided at the other end of the balanced cable. The balanced to unbalanced converter is provided with a BNC connector whereby it is configured to be connectable to a coaxial cable via the BNC connector.

### CITATION LIST

### Patent Literature

### Patent Literature 1

Japanese Unexamined Patent Application Publication No. Hei 05 (1993)-174903

### Patent Literature 2

Japanese Unexamined Patent Application Publication No. Hei 05 (1993)-152997

### Patent Literature 3

Japanese Unexamined Utility Model Application Publication No. Hei 05 (1993)-039026, and entire specification

### SUMMARY OF INVENTION

### Technical Problem

Each Patent Literature as described above discloses the balanced to unbalanced converter with cable on the premise of the network environment using the balanced cable and the unbalanced cable mixedly. When connecting the transmission system devices which perform data communication using differential signal, it is necessary to connect each of the transmission system devices to the balanced to unbalanced converter with balanced cable using a modular plug, and to connect the unbalanced cable to each of BNC connectors of those two balanced to unbalanced converters. Additionally, the single unit of transformer using the toroidal core can be incorporated into the connector for the single twisted pair cable. However, incorporation of four units of transformers into a connector for four twisted pair cables may cause problems of increase in the size and weight of the connector.

There is a need for development of an electric LAN cable which does not require a power source, and enables data communication between transmission system devices which perform data communication using differential signal while exceeding the transmission distance of 100 m as the maximum standardized value.

There is also a need for development of a simply configured electric LAN cable, which does not require a network environment using balanced cables and unbalanced cables mixedly.

Accordingly, it is an object of the present invention to provide an electric LAN cable which enables data communication between transmission system devices, which perform data communication using differential signal, while exceeding the transmission distance of 100 m as the maximum standardized value, and a connector for the LAN cable.

It is another object of the present invention to provide a passive electric LAN cable which enables transmission while exceeding the transmission distance of 100 m without requiring a power source, and a connector for the LAN cable.

It is still another object of the present invention to provide a simply configured electric LAN cable without requiring a network environment using balanced cable and unbalanced cables mixedly, and a connector for the LAN cable.

### Solution to Problem

According to one aspect of the present invention, a LAN cable is configured as below.

A LAN cable includes: a LAN cable body having n (n is an integer equal to or greater than 4) unbalanced cables as n pairs of signal lines housed in a sheath; and a connector plug which is provided to at least one end of the LAN cable body, and is to be coupled to a connector jack at the side of a transmission system device which performs data communication using differential signal. The connector plug includes n pairs of contact pins, a circuit substrate, and a connector body for surrounding the n pairs of contact pins and the circuit substrate. The circuit substrate includes: n pairs of cable-side terminals electrically connected to the respective conductor pairs of the n unbalanced cables; n pairs of pin-side terminals electrically connected to the respective pairs of the n pairs of the contact pins; n units of surface-mounted balanced to unbalance converters; and electric wirings for establishing one-to-one electric connection among the respective pairs of the cable-side terminals, the respective converters of the surface-mounted balanced to unbalanced converters, and the respective pairs of the pin-side terminals.

As a preferred embodiment of the LAN cable according to the present invention, the connector plug may be a modular connector.

Further, as a preferred embodiment of the LAN cable according to the present invention, the modular connector may be RJ45.

As a preferred embodiment of the LAN cable according to the present invention, the connector plug may be an industrial X-code connector.

As a preferred embodiment of the LAN cable according to the present invention, the industrial X-code connector may be an M12 series X-code connector.

According to another aspect of the present invention, a LAN cable connector is configured as below.

A LAN cable connector includes a connector plug which is capable of being attached to at least one end of a LAN cable body having n (n is an integer equal to or greater than 4) unbalanced cables as n pairs of signal lines housed in a sheath, and is capable of being coupled to a connector jack at the side of a transmission system device which performs data communication using differential signal. The connector plug includes n pairs of contact pins, a circuit substrate, and a connector body for surrounding the n pairs of contact pins and the circuit substrate. The circuit substrate includes: n pairs of cable-side terminals to be electrically connected to the respective conductor pairs of the n unbalanced cables; n pairs of pin-side terminals electrically connected to the respective pairs of the n pairs of the contact pins; n units of surface-mounted balanced to unbalanced converters; and electric wirings for establishing one-to-one electric connection among the respective pairs of the n pairs of the cable-side terminals, the respective converters of the n units of the surface-mounted balanced to unbalanced converters, and the respective pairs of the n pairs of the pin-side terminals.

As a preferred embodiment of the LAN cable connector according to the present invention, the connector plug may be compatible with a modular connector.

Further, as a preferred embodiment of the LAN cable connector according to the present invention, the modular connector may be RJ45.

Further, as a preferred embodiment of the LAN cable connector according to the present invention, the connector plug may be compatible with an industrial X-code connector.

Further, as a preferred embodiment of the LAN cable connector according to the present invention, the industrial X-code connector may be a M12 series X-code connector.

### Advantageous Effects of Invention

The use of the electric LAN cable having n unbalanced cables as the n pairs of signal lines housed in the sheath attains data communication between the transmission system devices which perform data communication using differential signal while exceeding the transmission distance of 100 m as the maximum standardized value.

The electric LAN cable allows transmission of n-channel signals without requiring the power source while exceeding the transmission distance of 100 m.

The network environment can be simply configured without requiring mixed use of balanced cables and unbalanced cables.

Any other objects and advantages as well as those described above will be clearly understood with reference to descriptions of the following embodiments. The present invention is not limited to the following embodiments which are mere examples.

### BRIEF DESCRIPTION OF DRAWINGS

FIG. 1 is a schematic view illustrating an example of a LAN cable.

FIG. 2 is an enlarged sectional view of a LAN cable body.

FIG. 3 is a schematic plan view illustrating an inner structure of a connector of a LAN cable as an example.

FIG. 4 is a schematic front view illustrating the inner structure of the connector of the LAN cable as an example.

FIG. 5 is a circuit diagram illustrating an electrical connection between the cable body and the connector.

FIG. 6 is a schematic plan view illustrating the inner structure of the connector of the LAN cable as another example.

FIG. 7 is a schematic front view illustrating the inner structure of the connector of the LAN cable as another example.

FIG. 8 is a schematic plan view illustrating the inner structure of the connector of a LAN cable as another example.

FIG. 9 is a schematic front view illustrating the inner structure of the connector of a LAN cable as another example.

FIG. 10 is a partial perspective view of another example of the LAN cable.

FIG. 11 is a schematic plan view illustrating the inner structure of the connector of a LAN cable as another example.

FIG. 12 is a schematic front view illustrating the inner structure of the connector of a LAN cable as another example.

FIG. 13 is a schematic plan view illustrating the inner structure of the connector of a LAN cable as another example.

FIG. 14 is a schematic front view illustrating the inner structure of the connector of the LAN cable as another example.

### DESCRIPTION OF EMBODIMENTS

Preferred embodiments of the LAN cable according to the present invention are described in detail with reference to the drawings.

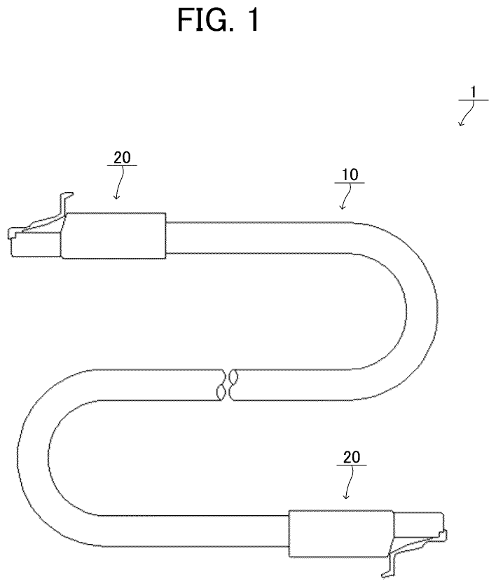

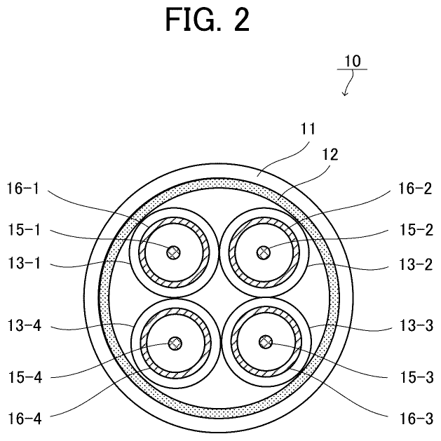

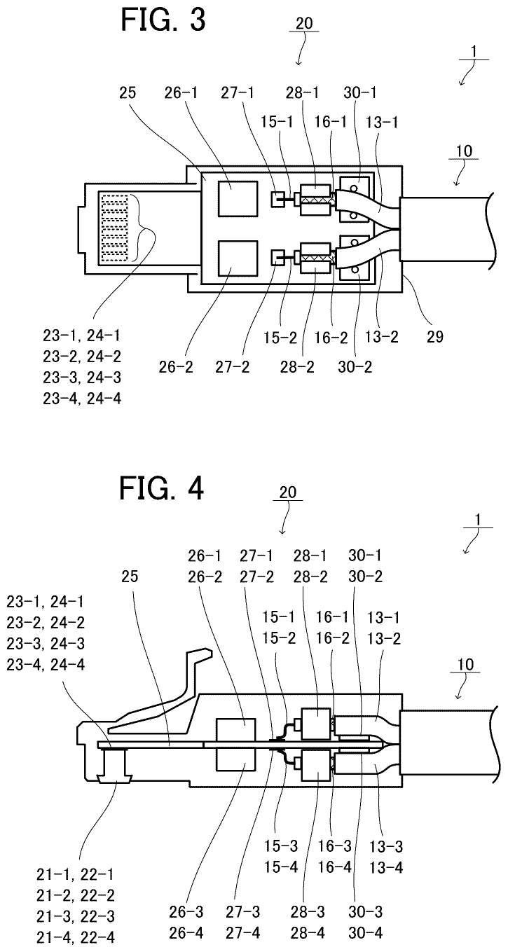

FIG. 1 is a schematic view illustrating an example of a LAN cable to which the present invention is applied. FIG. 2 is an enlarged sectional view of a LAN cable body. FIG. 3 is a schematic plan view illustrating an inner structure of a connector of the LAN cable as the example. FIG. 4 is a schematic front view illustrating the inner structure of the connector of the LAN cable as the example.

The LAN cable and the LAN cable connector according to the embodiment are exemplified by the use of an electric LAN cable classified as CAT6A, CAT6, and CAT5e as prescribed by the ANSI/TIA/EIA-568. Note that this is merely an example, and the present invention is not limited to this.

Referring to FIG. 1, a LAN cable 1 includes a cable body 10 and a connector 20. The cable body 10 is a LAN cable having four unbalanced cables as four pairs of signal lines housed in a sheath. FIG. 2 shows a cross section of the LAN cable. The connectors 20 may be attached to both ends of the cable body 10, respectively. In this example, the connector 20 is an RJ45 compatible connector plug which is capable of being coupled to an RJ45 connector jack at the side of a transmission system device which performs data communication using differential signal.

The cable body 10 is a 4-core (4-channel) coaxial multicable having four coaxial cables 13-1, 13-2, 13-3, 13-4 bundled with a binding tape 12 in a polyvinyl chloride sheath 11, for example. The coaxial cables 13-1, 13-2, 13-3, 13-4 include inner conductors 15-1, 15-2, 15-3, 15-4, and outer conductors 16-1, 16-2, 16-3, 16-4, respectively. An insulator of foamed polyethylene, for example, is interposed between the inner conductor and the outer conductor for insulation. The outer conductor has its periphery covered with a sheath of polyvinyl chloride, for example. Those coaxial cables correspond to the unbalanced cables, and the inner and the outer conductors of the respective coaxial cables correspond to the respective conductor pairs of the unbalanced cables.

Referring to FIG. 3 and FIG. 4, the inner structure of the connector of the LAN cable is described as an example. The connector 20 of the LAN cable 1 includes four pairs of contact pins, that is, eight contact pins 21-1, 22-1, 21-2, 22-2, 21-3, 22-3, 21-4, 22-4, a circuit substrate 25, and a connector body 29 which surrounds the four pairs of the contact pins and the circuit substrate.

Upon fitting to the RJ45 connector jack (8P8C modular connector jack) at the side of the transmission system device, the contact pins 21-1, 22-1, 21-2, 22-2, 21-3, 22-3, 21-4, 22-4 are electrically connected to the respective contacts at the connector jack side.

The circuit substrate 25 includes: four pairs of cable-side terminals 27-1, 28-1, 27-2, 28-2, 27-3, 28-3, 27-4, 28-4, which are electrically connected to the respective conductor pairs of the four coaxial cables, that is, 15-1, 16-1, 15-2, 16-2, 15-3, 16-3, 15-4, 16-4; four pairs of pin-side terminals 23-1, 24-1, 23-2, 24-2, 23-3, 24-3, 23-4, 24-4; and four surface-mounted balanced to unbalanced converters 26-1, 26-2, 26-3, 26-4. The four pairs of pin-side terminals 23-1, 24-1, 23-2, 24-2, 23-3, 24-3, 23-4, 24-4 are electrically connected to the respective pairs of four pairs of contact pins 21-1, 22-1, 21-2, 22-2, 21-3, 22-3, 21-4, 22-4.

In this example, among four pairs of cable-side terminals and four surface-mounted balanced to unbalanced converters, two pairs of cable-side terminals 27-1, 28-1, 27-2, 28-2 and two balanced to unbalanced converters 26-1, 26-2 are mounted on a front surface of the circuit substrate 25, and the remaining two pairs of cable-side terminals 27-3, 28-3, 27-4, 28-4, and the remaining two balanced to unbalanced converters 26-3, 26-4 are mounted on a back surface of the circuit substrate 25.

The respective pairs of cable-side terminals may be constituted by conductive pads 27-1, 27-2, 27-3, 27-4 to be soldered to the respective leading ends of the inner conductors 15-1, 15-2, 15-3, 15-4 of the coaxial cables 13-1, 13-2, 13-3, 13-4, and conductive terminals 28-1, 28-2, 28-3, 28-4 for clamping the respective peripheries of the outer conductors 16-1, 16-2, 16-3, 16-4 from both sides. The sheath for the coaxial cables 13-1, 13-2, 13-3, 13-4 may be mechanically fixed onto the substrate by cable clamps 30-1, 30-2, 30-3, 30-4. Instead of soldering the inner conductors to the conductive pads, the inner conductors may be fixed to the conductive terminals by the process of either pressure contact or screwing. Instead of clamping the outer conductors by the conductive terminals, the outer conductors may be fixed by the process of either soldering or screwing.

Each of the surface-mounted balanced to unbalanced converters 26-1, 26-2, 26-3, 26-4 may be exemplified by 1:1.33 Transmission Line Balun Transformer of MACOM Technology Solutions Inc. This transformer serves as the balanced to unbalanced converter between the balanced line with characteristic impedance of 100Ω, and the unbalanced line with characteristic impedance of 75Ω. In contrast to the balanced to unbalanced converter using the generally employed toroidal core, the surface-mounted balanced to unbalanced converter as described above is a short and compact electronic component having its size of approximately 4 mm×4 mm×3 mm. Even in the case where the multiple surface-mounted balanced to unbalanced converters are mounted on both surfaces of the substrate, the connector body for surrounding those converters may be kept compact in size (especially in the height). Note that the above-described case is merely an example. It is therefore possible to use other types of balanced to unbalanced converters configured to be adapted to the surface mounting process.

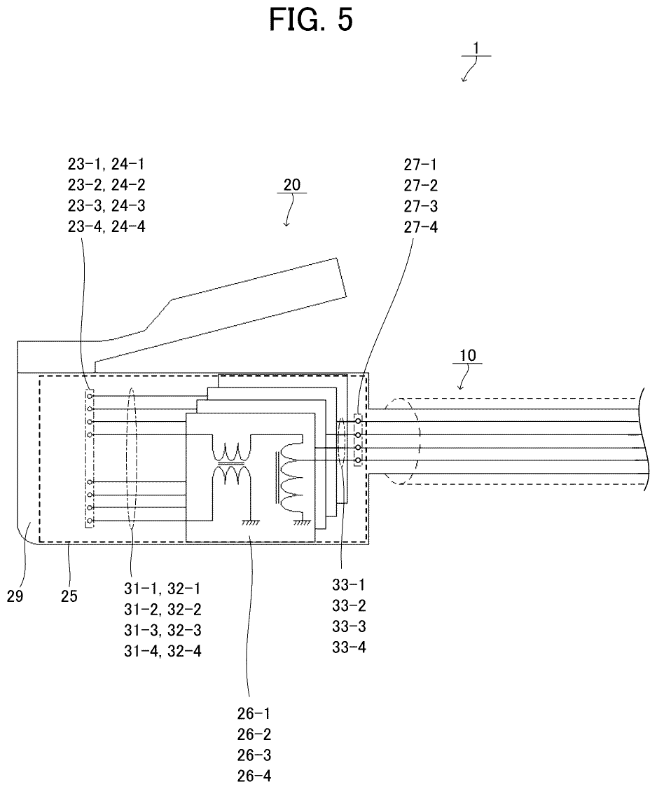

Referring to the circuit diagram shown in FIG. 5, the electrical connection between the cable body and the connector is described. The circuit substrate 25 includes electric wirings 31-1, 32-1, 31-2, 32-2, 31-3, 32-3, 31-4, 32-4, 33-1, 33-2, 33-3, 33-4. The electric wirings 31-1, 32-1, 31-2, 32-2, 31-3, 32-3, 31-4, 32-4 establish one-to-one electrical connection between balanced pairs of the respective surface-mounted balanced to unbalanced converters 26-1, 26-2, 26-3, 26-4, and the respective pairs of the pin-side terminals 23-1, 24-1, 23-2, 24-2, 23-3, 24-3, 23-4, 24-4. The electric wirings 33-1, 33-2, 33-3, 33-4 establish one-to-one electrical connection between the single end of the respective surface-mounted balanced to unbalanced converters 26-1, 26-2, 26-3, 26-4, and the cable-side terminals 27-1, 27-2, 27-3 27-4 (conductive pads). Although a ground wire is not shown in FIG. 5, the ground wire electrically connects ground sides of the respective converters and the cable-side terminals 28-1, 28-2, 28-3, 28-4 (conductive terminals, see FIG. 3 and FIG. 4).

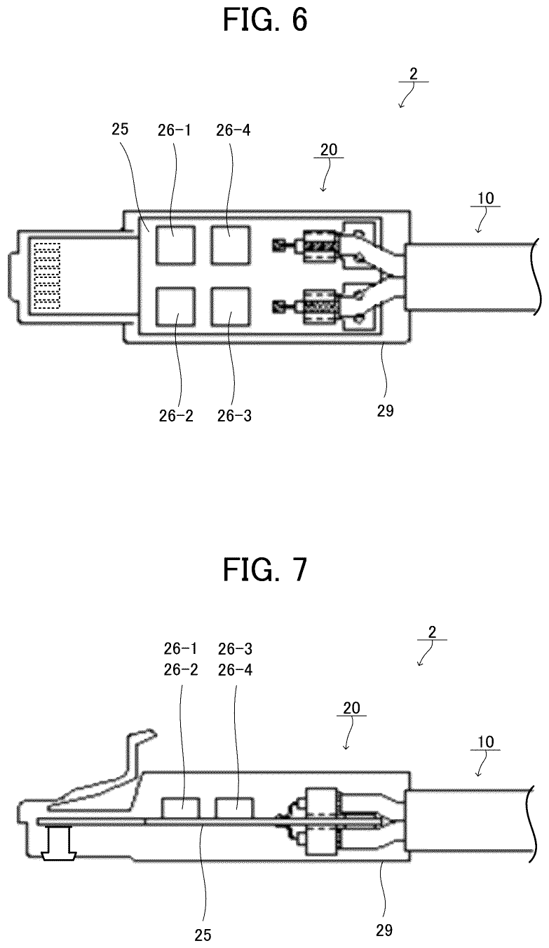

Various modifications to both the LAN cable and the connector may be made. Referring to FIG. 6 and FIG. 7, an inner structure of the connector of the LAN cable is described as another example. A connector 20 of a LAN cable 2 is configured differently from the connector 20 of the LAN cable 1 as shown in FIG. 3 and FIG. 4 in an arrangement of the surface-mounted balanced to unbalanced converters 26-1, 26-2, 26-3, 26-4, which are mounted on the circuit substrate 25 surrounded by the connector body 29. Specifically, in the connector 20 of the LAN cable 2, four converters are mounted in two longitudinal rows on the surface of the circuit substrate 25. As described above, the surface-mounted balanced to unbalanced converter is a compact electronic component and its height is short. This change in the arrangement may only require a slight extension of the length of the connector body 29.

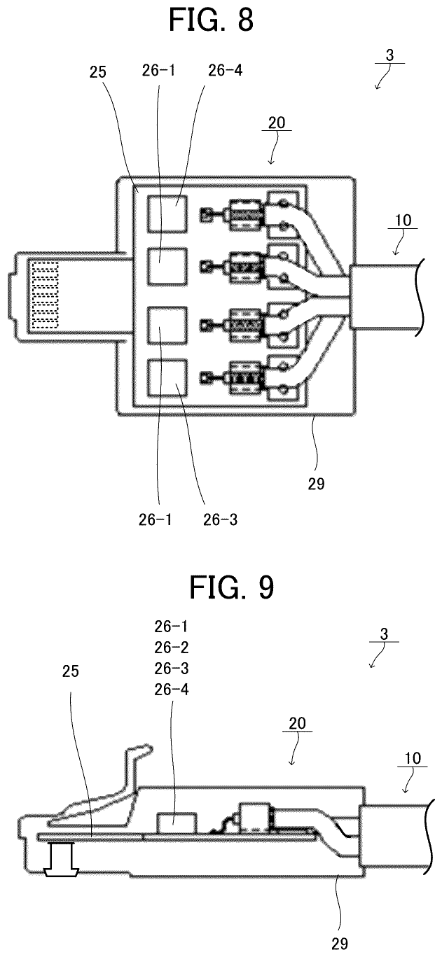

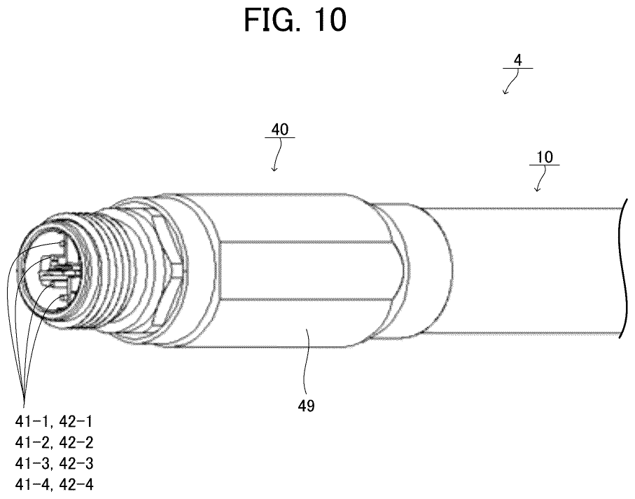

Referring to FIG. 8 and FIG. 9, the inner structure of the connector of the LAN cable is described as further another example. A connector 20 of a LAN cable 3 is differently configured from the connector 20 of the LAN cable 2 as shown in FIG. 6 and FIG. 7 in that the four surface-mounted balanced to unbalanced converters 26-1, 26-2, 26-3, 26-4 are mounted on the surface of the circuit substrate 25 in a widthwise single row arrangement. Change in the arrangement as described above doubles the width of the connector body 29. As the converter, however, is the electronic component short in height, the size of the connector body 29 may be made smaller than that of the connector assumed in the case where generally employed converters each using the toroidal core is similarly mounted and arranged.

The description has been made about examples of attaching the modular connector, especially, the RJ45 compatible connector to the cable body of the LAN cable. The connector of different type may also be attached. In an example, the connector compatible with an industrial X-code connector may be attached.

The industrial X-code connector is an industrial connector for cables classified as CAT6A, which is adapted to the transmission speed of 10 Gbps. For example, the industrial X-code connector is exemplified by an M12 series X-code connector, having a 4-channel/8-conductor contact pins. A LAN cable 4 as further another example of the LAN cable may be configured to attach a connector 40 compatible with the M12 series X-code connector having 4-channel/8-conductor contact pins 41-1, 42-1, 41-2, 42-2, 41-3, 42-3, 41-4, 42-4 to the cable body 10 of a 4-core (4-channel) coaxial multicable in place of the connector compatible with the modular connector.

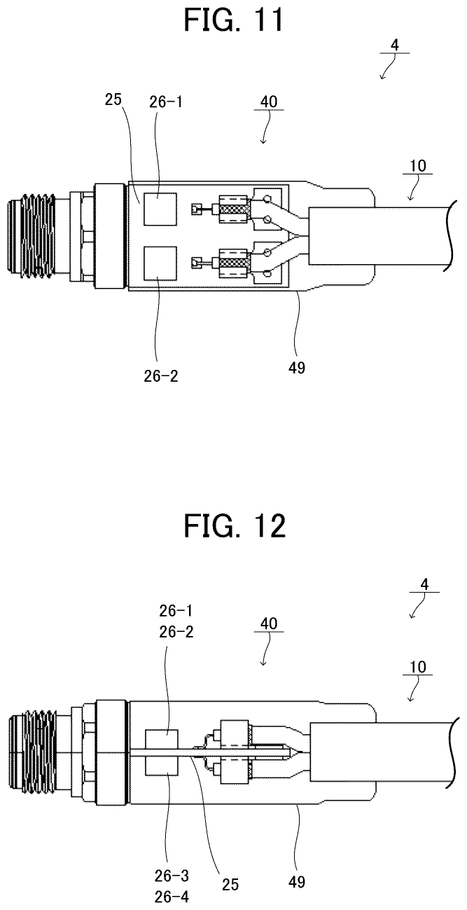

FIG. 11 and FIG. 12 represent an inner structure of the connector as another example of the LAN cable. A connector 40 of a LAN cable 4 is different from the RJ45 compatible connector plug in that the connector 40 of the LAN cable 4 includes contact pins for the M12 series X-code connector, and has configuration of a connector body 49 of sleeve type. As the inner structure of the connector 40 is similar to that of the connector 20 of the LAN cable 1 as shown in FIG. 3 and FIG. 4, detailed explanations of the inner structure are omitted.

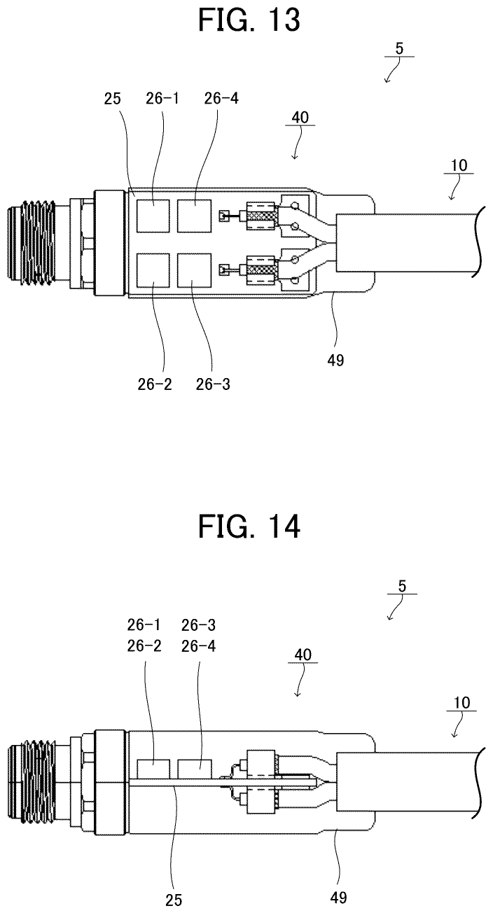

FIG. 13 and FIG. 14 represent the inner structure of the connector as another example of the LAN cable. As the inner structure of the connector 40 of the LAN cable 4 which is compatible with the M12 series X-code connector, is similar to that of the connector 20 of the LAN cable 2 as shown in FIG. 6 and FIG. 7, detailed explanations of the inner structure are omitted.

Based on an example of the LAN cable according to the present invention, a LAN cable having the cable body length in excess of 100 m was prepared, and subjected to measurement of cable characteristics, especially, the attenuation. The measurement results are described in an example as below.

### Example

A 75Ω coaxial multicable “V4-2.5CHW” with length of 150 m manufactured by Canare Electric Co., Ltd, and four 1:1.33 Transmission Line Balun Transformers “MABA-009092-CT1A40” manufactured by MACOM Technology Solutions Inc. were used for preparing the LAN cable configured as shown in FIG. 1 to FIG. 5. The attenuation of the prepared LAN cable was 40.8 dB (500 MHz), which satisfies the LAN cable standard classified as CAT6A, CAT6, CTA5e. This shows that it attains the electric LAN cable enabling transmission while exceeding the transmission distance in excess of 100 m, up to 200 m.

The embodiments based on a plurality of examples describe the use of the 75Ω coaxial multicable as the cable body, and 100Ω balanced-75Ω unbalanced converter. Coaxial multicable with characteristic impedance of 50Ω, and 100Ω balanced-50Ω unbalanced converter may also be used. Moreover, the 4-core/4-channel LAN cable adapted to the 8P8C modular connector (RJ45) is merely an example. Accordingly, the present invention may be applied to the multicore/multichannel LAN cable in the future, for example, the LAN cable with 5 or more cores and 5 or more channels.

### INDUSTRIAL APPLICABILITY

The present invention may be widely applied to LAN cable for interconnection between transmission system devices which perform data communication using differential signal while exceeding the transmission distance of 100 m.

### LIST OF REFERENCE SIGNS

1, 2, 3, 4: LAN cable
10: cable body
11: sheath
12: binding tape
13-1, 13-2, 13-3, 13-4: coaxial cable
15-1, 15-2 15-3, 15-4: inner conductor
16-1, 16-2 16-3, 16-4: outer conductor
20, 40: connector
21-1, 22-1, 21-2, 22-2, 21-3, 22-3, 21-4, 22-4, 41-1, 42-1, 41-2,
42-2, 41-3, 42-3, 41-4, 42-4: contact pin
23-1, 24-1, 23-2, 24-2, 23-3, 24-3, 23-4, 24-4: pin-side terminal
25: circuit substrate
26-1, 26-2, 26-3, 26-4: surface-mounted balanced to unbalanced converter
27-1, 27-2, 27-3, 27-4: conductive pad (cable-side terminal)
28-1, 28-2, 28-3, 28-4: conductive terminal (cable-side terminal)
29, 49: connector body
30-1, 30-2, 30-3, 30-4: cable clamp
31-1, 32-1, 31-2, 32-2, 31-3, 32-3, 31-4, 32-4, 33-1, 33-2, 33-3,
33-4: electric wiring

1. A LAN cable comprising:
a LAN cable body having n (n is an integer equal to or greater than 4) unbalanced cables as n pairs of signal lines housed in a sheath; and
a connector plug which is provided to at least one end of the LAN cable body, and is to be coupled to a connector jack at the side of a transmission system device for performing data communication using a differential signal, wherein,
the connector plug includes n pairs of contact pins, a circuit substrate, and a connector body for surrounding the n pairs of contact pins and the circuit substrate, and
the circuit substrate includes:
n pairs of cable-side terminals which are electrically connected to the respective conductor pairs of the n unbalanced cables;
n pairs of pin-side terminals which are electrically connected to the respective pairs of the n pairs of contact pins;
n units of surface-mounted balanced to unbalanced converters; and
electric wirings for establishing one-to-one electric connection among the respective pairs of the n pairs of the cable-side terminals, the respective converters of the n units of the surface-mounted balanced to unbalanced converters, and the respective pairs of the n pairs of the pin-side terminals.

2. The LAN cable according to claim 1, wherein the connector plug is compatible with a modular connector.

3. The LAN cable according to claim 2, wherein the modular connector is of RJ45 type.

4. The LAN cable according to claim 1, wherein the connector plug is compatible with an industrial X-code connector.

5. The LAN cable according to claim 4, wherein the industrial X-code connector is an M12 series X-code connector.

6. The LAN cable according to claim 1, wherein a part of the n units of the surface-mounted balanced to unbalanced converters is mounted on a front surface of the circuit substrate, and the remaining part is mounted on a back surface of the circuit substrate.

7. A LAN cable connector comprising a connector plug which is allowed to be attached to at least one end of a LAN cable body having n (n is an integer equal to or greater than 4) unbalanced cables as n pairs of signal lines housed in a sheath, and is allowed to be coupled to a connector jack at the side of a transmission system device for performing data communication using a differential signal, wherein,
the connector plug includes n pairs of contact pins, a circuit substrate, and a connector body for surrounding the n pairs of contact pins and the circuit substrate, and
the circuit substrate includes:
n pairs of cable-side terminals which are to be electrically connected to the respective conductor pairs of the n unbalanced cables;
n pairs of pin-side terminals which are electrically connected to the respective pairs of the n pairs of the contact pins;
n units of surface-mounted balanced to unbalanced converters; and
electric wirings for performing one-to-one electric connection among the respective pairs of the n pairs of cable-side terminals, the respective converters of the n units of the surface-mounted balanced to unbalanced converters, and the respective pairs of the n pairs of the pin-side terminals.

8. The LAN cable connector according to claim 7, wherein the connector plug is compatible with a modular connector.

9. The LAN cable connector according to claim 8, wherein the modular connector is of RJ45 type.

10. The LAN cable connector according to claim 7, wherein the connector plug is compatible with an industrial X-code connector.

11. The LAN cable connector according to claim 10, wherein the industrial X-code connector is an M12 series X-code connector.

12. The LAN cable connector according to claim 7, wherein a part of the n units of surface-mounted balanced to unbalanced converters is mounted on a front surface of the circuit substrate, and the remaining part is mounted on a back surface of the circuit substrate.
